(19) United States
(12) Patent Application Publication
(10) Pub. No.: US 2006/0035706 A1
(43) Pub. Date: Feb. 16, 2006

(54) Wagering game with payoff rounding feature

(76) Inventors: Alfred Thomas, Las Vegas, NV (US); Mark B. Gagner, West Chicago, IL (US); Rory L. Block, Carson City, NV (US); Jason Smith, Arlington Heights, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/199,688

(22) Filed: Aug. 9, 2005

Related U.S. Application Data
(60) Provisional application No. 60/601,308, filed on Aug. 13, 2004.

(51) Int. Cl. G06F 19/00

(52) U.S. Cl. 463/27

(57) ABSTRACT

A method for playing a wagering game allowing a player to be eligible for a progressive jackpot having an actual value. The method comprises conducting the wagering game that has a randomly selected outcome selected from a plurality of outcomes, and displaying a displayed value of the progressive jackpot to the player. The method further includes increasing the displayed value by increments of a first denomination, and awarding a player an award value of the progressive jackpot in response to the player achieving the progressive jackpot. The award value is greater than the displayed value and is equally divisible by a second denomination that is larger than the first denomination. Other methods are provided for creating an escrow pool for funding the difference between the displayed and award values, and also for awarding multiple jackpots from a plurality of progressive jackpots.

### CROSS-REFERENCE TO RELATED APPLICATIONS

This application claims the benefit of priority of U.S. Provisional Patent Application No. 60/601,308, filed Aug. 13, 2004, which is hereby incorporated by reference in its entirety.

### FIELD OF THE INVENTION

The present invention relates generally to gaming terminals and, more particularly, to a gaming terminal having a payoff rounding feature.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

As progressive jackpot games become more advanced, there is a need to display values of the progressive jackpot and award values of the progressive jackpot in ways that appeal to the player.

### SUMMARY OF THE INVENTION

The present invention solves the aforementioned problems by creating actual values and the displayed values of the progressive jackpot that are increased and incremented with different denominations.

The present invention involves a method for playing a wagering game on a gaming terminal. The wagering game allows a player to be eligible for a progressive jackpot having an actual value. The method comprises conducting the wagering game that has a randomly selected outcome selected from a plurality of outcomes, and displaying a displayed value of the progressive jackpot to the player. The displayed value is less than the actual value. The method further includes increasing the displayed value by increments of a first denomination, and awarding a player an award value of the progressive jackpot in response to the player achieving the progressive jackpot. The award value may be greater than the displayed value and is equally divisible by a second denomination that is larger than the first denomination.

In another aspect, the present invention involves a method for playing a wagering game on a gaming terminal. The wagering game allows a player to be eligible for a progressive jackpot with an actual value. The method comprises, in response to wager inputs, conducting the wagering game having a randomly selected outcome selected from a plurality of outcomes, and displaying a displayed value of the progressive jackpot to players competing for the progressive jackpot. The displayed value is equal to or less than an award value of the progressive jackpot. The method further includes maintaining the displayed value and the award value as equal amounts until an escrow pool for the progressive jackpot has been established. The escrow pool is funded with a portion of the wager inputs and is, preferably, at least a maximum difference between the award value and the displayed value. The method further includes, after the escrow pool has been established, increasing the displayed value and the award value in response to additional wager inputs.

In a further aspect of the invention, the present invention is a method for playing a wagering game on a gaming terminal. The wagering game allows a player to be eligible for a plurality of progressive jackpots. Each of the plurality of progressive jackpots has an actual value. The method comprises, in response to wager inputs, conducting the wagering game that has a randomly selected outcome selected from a plurality of outcomes, and displaying a displayed value for each of the progressive jackpots to players competing for the progressive jackpots. The displayed value is equal to or less than an award value of the corresponding progressive jackpot. The method includes, in response to a player achieving at least two jackpots from the plurality of progressive jackpots, adding the displayed value of the at least two progressive jackpots to result in a total displayed value, and awarding the player with a total award value that is greater than the total displayed value. The total award value is an equal increment of a denomination used for playing the wagering game. The difference between the total award value and the total displayed value can be funded by an escrow pool established by a portion of the wager inputs.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIG. 3 illustrates a display of a basic game on the gaming terminal of FIG. 1.

FIG. 4 illustrates a first progressive jackpot screen on the gaming terminal of FIG. 1.

FIG. 5 illustrates a second progressive jackpot screen on the gaming terminal of FIG. 1.

FIG. 6 is a flow diagram showing the awarding of a progressive jackpot according to one embodiment of the present invention.

FIG. 7 is a flow diagram showing the displaying of a progressive jackpot according to one embodiment of the present invention.

FIG. 8 is a flow diagram showing the establishing of an escrow pool that is used in accordance with one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

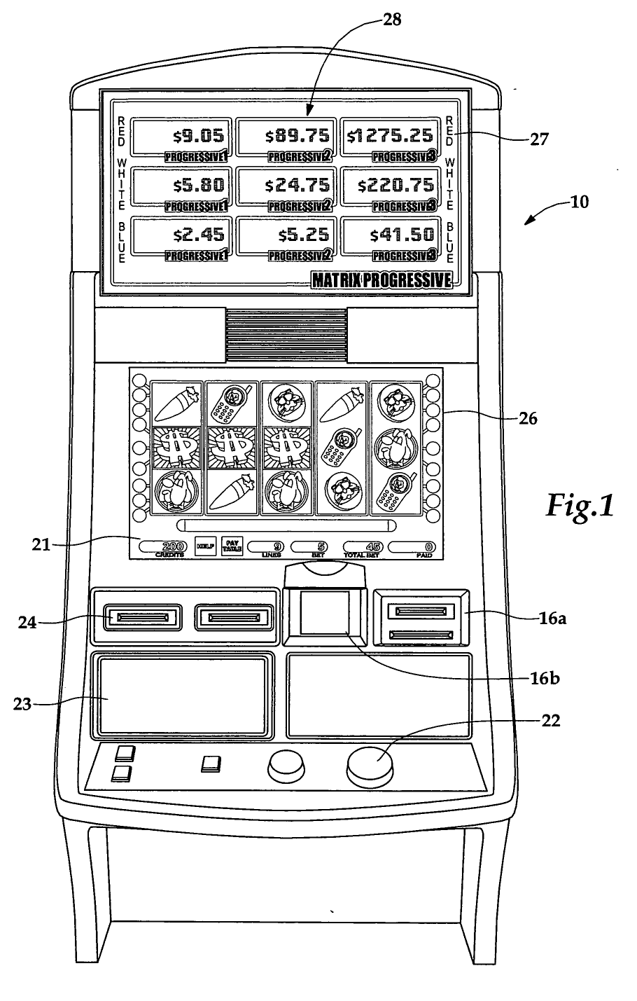

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. In this embodiment, the secondary display 27 displays a progressive jackpot array 28 (or matrix). While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the information reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

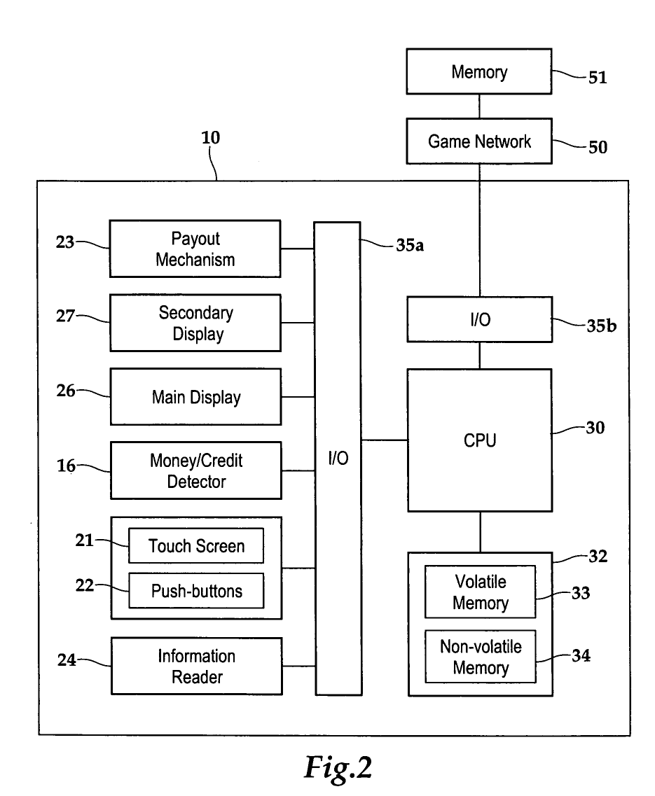

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks). The gaming network 50 may have a system memory 51 that is used for performing some or all of these functions.

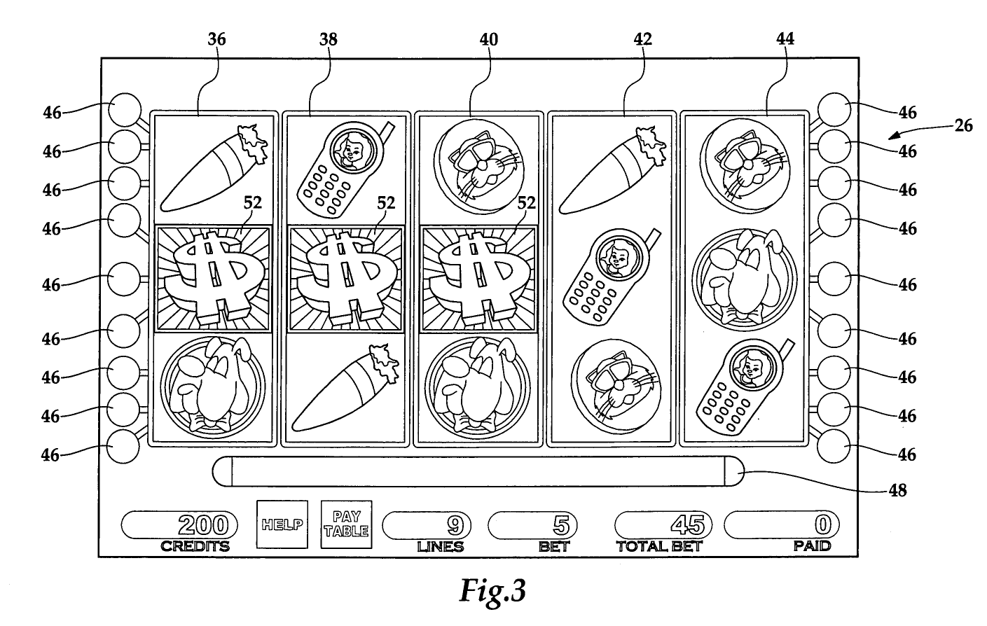

Turning now to FIG. 3, the main display 26 of one embodiment of the present invention is shown in more detail. In this embodiment, the basic wagering game is a slot machine game, with symbols on five different reels 36, 38, 40, 42, 44. The reels 36-44 may be either traditional mechanical reels or they may be computer-generated images of reels, with each reel including a plurality of symbols. The payline indicators 46 indicate a randomly selected outcome for each payline, which is the combination of symbols on the reels 36-44. Thereafter, an outcome indicator 48 indicates whether the outcome has resulted in a winning outcome or a non-winning outcome. In the present example, various combinations of the symbols can result in winning outcomes, which include monetary and non-monetary prizes. The non-monetary prizes can include free spins, multipliers, and entry into an advanced game such as bonus game or a progressive game. While nine paylines 46 are shown, a gaming terminal 10 with a single payline will also work with the present invention.

In this particular embodiment, a particular group of symbols 52 indicates that the player has achieved one of the progressive-jackpot outcomes. In this embodiment, a combination of three dollar signs along an active payline indicates the progressive-jackpot outcome. In other embodiments, all award-winning combinations generate the progressive-jackpot outcome 52 or a single particular symbol may generate the progressive-jackpot outcome 52.

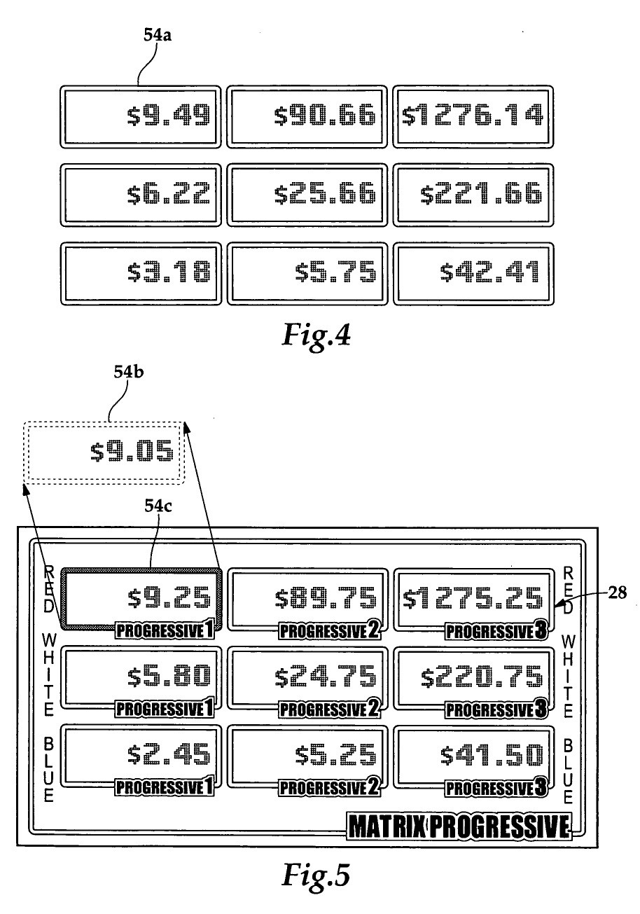

The progressive-jackpot outcome 52 corresponds to the progressive jackpot array (or matrix) 28 illustrated on the secondary display 27, which will be described with respect to FIGS. 4 and 5. Generally speaking, in each of the figures, the progressive jackpot array 28 includes nine different progressive jackpots. The columns in the array 28 are indicated by progressive numbers (e.g., progressive 1, progressive 2, progressive 3) and the rows are indicated by colors (e.g., red, white, and blue). The progressive jackpots are initially created by a base amount that is reset after the progressive jackpot is won. The progressive jackpot is then increased by a portion of the wager inputs from players competing for the progressive jackpots. The amount added to the progressive jackpot can be a fixed percentage of each wager input, a variable percentage of each wager input, or dictated by the symbol combination of the basic game shown in FIG. 3.

When a progressive jackpot receives a contribution due a player's wager input, the jackpot is generally increased by an amount that is less than one unit of a denomination that is played at the gaming terminal 10. In accordance with the present invention, the increase in actual value of the progressive jackpots is not necessarily directly proportional to the increase in the displayed value of the progressive jackpot. In other words, a progressive jackpot may, in some instances, increase at a rate that is proportional to the actual value. In other instances, however, the increase in the displayed value may have no relation to the increase in the actual value. In doing so, the present invention provides for a buffer between the displayed value and the actual value. The buffer typically fluctuates based on the wager inputs that dictate the actual value of the progressive jackpot. The buffer provides flexibility in allowing the gaming terminal 10 to continuously display increases in the displayed value of the progressive jackpot, although there has not been any recent wager inputs to have caused an increase in the actual value of the progressive jackpot. As such, the players perceive that the value is continuously increasing.

FIG. 4 illustrates a table that shows the actual values of the progressive jackpots in the array 28 displayed on the secondary display 27 of the gaming terminal 10 in FIG. 1. The actual values of the progressive jackpots in FIG. 4 are more than the displayed value of the progressive jackpots as shown in FIG. 1.

Turning now to FIG. 5, a player has achieved the progressive jackpot outcome 52 that is shown in FIG. 3. In this example, the outcome 52 indicates that the player has achieved the progressive jackpot award 54 in the first row, first column. The actual value 54a of this jackpot is $9.49, as shown in FIG. 4. Although the displayed value 54b of the progressive jackpot is $9.05, as shown in FIG. 1 and the breakout window of FIG. 5, the player believes that he or she has experienced a windfall in that the player has received an award value 54c of $9.25, which has been highlighted in FIG. 5. Thus, after the win, the display 27 in FIG. 5 shows the displayed values of all other jackpots, and the award value 54c of the winning jackpot. The player typically has more excitement when they win the progressive jackpot award 54, because it looks like they are obtaining a windfall. In reality, however, the actual value 54a corresponding to the progressive jackpot award 54 is $9.49, as shown in FIG. 4. Thus, the player is not shown the actual amount of the progressive jackpot, but instead is shown an amount less than the actual value of the progressive jackpot. The award value 54c of the progressive jackpot is greater than or equal to the displayed value 54b, but no more than the actual value 54a. Any surplus between the actual value 54a and the award value 54c may be added to the base value of the subsequent jackpot 54 for the first row, first column of the array 28 after it has been reset to its base value.

As shown in FIGS. 4 and 5, the displayed values of the progressive jackpots are provided in an increment of and equally divisible by a first denomination. For example, in the Progressive 1 column, the first denomination is $0.05 (i.e., a nickel). However, the award value for the Progressive 1 column is an increment of and equally divisible by a second denomination, which in this case is $0.25 (i.e., a quarter). Thus, the award value is rounded up to the next increment unit of the second denomination. Had the player won the White row of the Progressive 2 column, then he or she would have been awarded the next award value as incremented by quarters, or $6.00. And had he or she won the Blue row of the Progressive 2 column, then he or she would have been awarded the next award value of $2.50 as incremented by quarters.

The progressive jackpots can be incremented in various denominations in accordance with the present invention. For example, the displayed values of the Progressive 2 and Progressive 3 columns are incremented and equally divisible by $0.25 (i.e., a quarter), but the award values are incremented in units of $1.00 (i.e., a dollar). Hence, winning any of the progressive jackpots in the Progressive 2 and Progressive 3 columns will result in an award value that is the rounded from the displayed value to the next dollar.

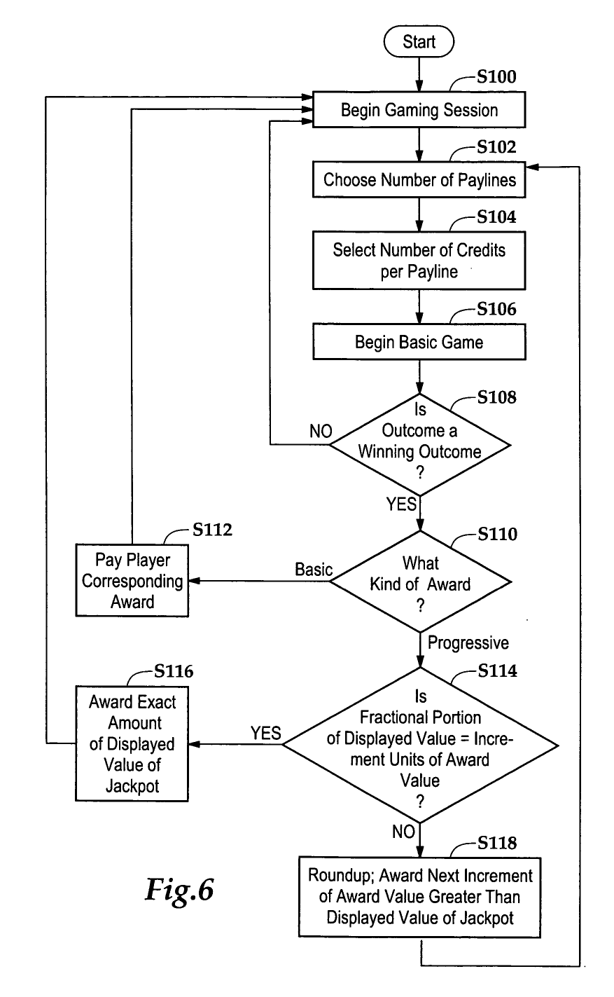

The process of this progressive jackpot system will now be described in more detail in reference to the flow chart in FIG. 6 in which it is assumed that the progressive jackpot award is triggered by an outcome in the basic game. In step S100, a player at the gaming terminal 10 begins a gaming session by any conventional method (e.g., inserting coins or using credits). The gaming terminal 10 typically has a basic wagering game that involves a player making various inputs, including choosing a number of paylines to play, as in step S102. In some embodiments, there are multiple paylines, as shown in the gaming terminal 10 of FIG. 1. For embodiments having a single payline, the step S102 would be skipped. After choosing how many paylines to play, at step S104, the player selects how many credits (e.g., 1-5) to wager on each payline.

Regarding eligibility for the progressive jackpots, in some embodiments, the player is only eligible for any of the progressive jackpots if the player chooses to play all of the paylines and/or the player wagers the maximum amount on each of the paylines played. In other embodiments, the player is automatically eligible to play for the progressive jackpots, and is not required to make a minimum wager or to play a minimum number of lines. In some other embodiments, there is a “side-wager” option that allows the player to be eligible for the progressive jackpots. The “side-wager” option is described in U.S. patent application Ser. No. 10/659,878, filed on Sep. 11, 2003, entitled “Gaming Machine With Multi-Level Progressive Jackpot,” which is commonly owned and herein incorporated by reference in its entirety.

At step S106, the player begins the basic wagering game, thereby causing the reels to spin. A randomly selected outcome is a selected by the CPU 30 (FIG. 2) and a symbol combination that corresponds to the randomly selected outcome is displayed. At step S108, it is determined if the randomly selected outcome is one of the winning outcomes shown in the pay table. If the answer is “no,” then the gaming system returns to step S100, and play begins again.

If the answer is “yes” at S108, then the gaming system progresses to step S110, and there is a decision as to whether the winning outcome results in a basic game award or a progressive jackpot. If the answer is that the outcome results in a basic game award, the system progresses to step S112, and the player is awarded a set amount that is associated with that particular winning outcome (generally available to a player in a pay table).

If the answer is that the outcome results in a progressive jackpot award, the system next progresses to step S114 to determine how much the player should be awarded. At step S114, the system determines whether the displayed value of the jackpot is equal to a unit of increment of the award value. If the answer is YES at step S114, then the award value of the jackpot is the exact value of the displayed jackpot as shown in step S116. If the answer is NO at step S114, then the award value of the jackpot is rounded up to the next increment of the award values as shown in step S118. Step S118 corresponds to the example of FIGS. 4 and 5 described above in which the fractional portion (i.e., $0.05) of the displayed value 54b of $9.05 was not equal to the increment units of the award value (i.e., $0.25), which caused a roundup to the next award-value increment, resulting in an award value 54c of $9.25. Of course, as in these examples, the actual value of the jackpot is still larger than the award value.

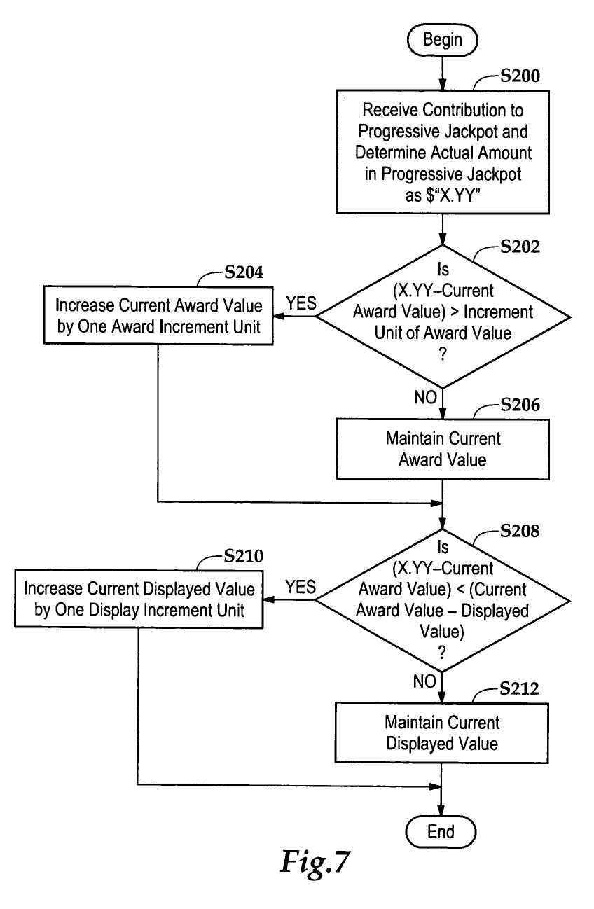

The flowchart of FIG. 7 describes one embodiment for incrementing the displayed values and the award values of the progressive jackpots. At step S200, the gaming system receives a contribution from a wager input by a player and determines the actual value of the particular progressive jackpot. The actual value is, in this algorithm, $X.YY, where YY is the fractional portion. At step S202, the gaming system determines whether the difference between the actual value and the current award value is greater than the increment unit of the award value. If it is greater, then, at step S204, the current award value is incremented by one unit used for the award value. (e.g., $0.25, $1.00, etc.). If the answer at step S202 is NO, then the current award value is maintained at the same value as shown in step S206. In short, steps S202-S206 describe one method for ensuring that the award value tracks the actual value of the progressive jackpot as progressive jackpot contributions are received by increasing the award value in known increments that typically correspond to a certain denomination (e.g., a nickel, a dime, a quarter, a dollar).

Steps S208-S212 determine whether a contribution should cause an increase in the current displayed value for a jackpot. At step S208, it is determined whether (i) the difference between the actual value and the current award value is less than (ii) the difference between the current award value and the displayed value. If the answer is YES, then at step S210, then the current displayed value is incremented by one displayed value unit increment, which is usually an increment (e.g., denomination) that is less than the award value unit increment. If the answer is NO at step S208, then the current displayed value is maintained at step s212. In summary, steps S208-S212 illustrate one way of incrementing the displayed value by ensuring the difference between the actual value and the current award value is about the same as the difference between the current award value and the displayed value.

In short, there are numerous algorithms like those examples in FIGS. 6 and 7 that could be employed to provide the incrementing of the award value and the displayed value, and to create a buffer between the actual value and the displayed value of the progressive jackpot. The buffer can be used to provide upward movement to the displayed value when no wager inputs are received within certain time period, or if wager inputs cause the actual value to increase at below a certain rate. In other words, a step within steps S208-212 could be added in FIG. 7 to increase the displayed value of the jackpot at a rate that is higher than the rate of increase of the actual value. This, of course, can only be done to a certain point where the displayed value approaches or is equal to the actual value. As subsequent wager inputs are then received, the displayed value may increase at a rate less than the rate of increase of the actual value so as to reestablish the buffer.

It should be noted that an award value that is less than the actual value, leaving a surplus, can result in a few possibilities. Most commonly, the surplus can be automatically added to the next progressive jackpot, which is reset to a base value after it has been won. Or, the surplus could be added to other progressive jackpots, if a multiple jackpot progressive system (FIGS. 4-5) is employed.

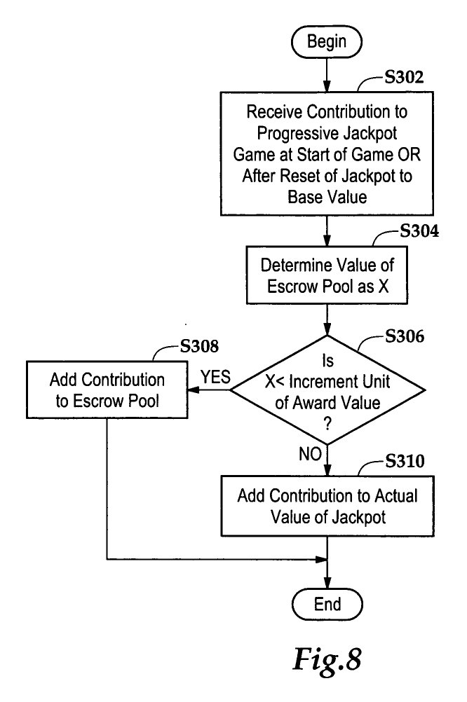

FIG. 8 describes a process by which an escrow pool is created to allow for the rounding-up of any jackpot values that are not equally divisible by a denomination that is payable by a gaming terminal. For this example in FIG. 8, it is assumed that the displayed value is substantially equal to the actual value of the progressive jackpot. In many situations, the portions of wagers inputs that are contributed to the progressive game are less than $0.01, such that the jackpot has an actual value that is a fraction of $0.01 and, hence, is substantially equal to the displayed value. At step 302, the contribution to a progressive jackpot is received. The value of the escrow pool (“X”) is then determined at step S304. If the value of the escrow pool is less than the increment unit of the award value, i.e., an answer of YES at step S304, then the contribution is added to the escrow pool at step S308 to increase its value. If the answer is NO at step S306, then the contribution is made to the actual value of the jackpot as shown in step S308.

The end result of FIG. 8 is a process by which the escrow pool allows the awarding of more money (i.e., rounding up) than the actual jackpot that is displayed to the user. As an example, if the gaming terminal receives $1.00 wagers and can only pay out in $1.00 increments, then this process allows the displayed value to be in an increment less than $1.00 (e.g., pennies, nickels, dimes, quarters). If the progressive award is achieved, then the award value of the jackpot is rounded up from the displayed value to the next dollar. More specifically, when a player achieves the progressive jackpot, the difference between an award value of $12.00 and the displayed value of $11.19, which is $0.81, is then reduced from the escrow pool of $1.00. Hence, the escrow pool starts the next progressive game session with a value of $0.19 and receives the initial contributions until its value is reestablished at $1.00. While the escrow pool is being established to the desired level, the displayed value of the progressive jackpot typically remains constant at its reset level.

The escrow pool concept of FIG. 8 can be used with a plurality of progressive jackpots, such as those shown in FIG. 5. The escrow can be established as the sum of all possible differences between the displayed value and the award value. For example, if the gaming terminal could only pay $0.25 (i.e., quarters) then the nine jackpots, which could be achieved simultaneously by one or more players, would require an escrow pool of $2.25 (9×$0.25). Alternatively, the winning of multiple progressives by one individual could result in the summing of the displayed values of the individual progressive jackpots that are achieved, and the total amount of the displayed values could be increased via the escrow pool to the next quarter increment. Thus, the escrow pool could be established at a lower value, perhaps as little as $0.25.

In other embodiments, the escrow pool could be paid out even if the payments will result in a negative value. This could happen if multiple progressives are hit in a very short period of time by several players. Over time, the negative value would be reestablished to a positive value and, preferably, to the desired value (e.g., $0.25 or $2.25).

Further, the escrow pool could also be used to create extra movement in the displayed value at times when the displayed values is stagnant due to minimal player activity. This way, the players are provided with more excitement as the jackpots always seem to be increasing. Hence, the escrow pool could act as a buffer that allows for movement of the displayed values.

The embodiment of FIG. 8 can be implemented with the actual-awarded-displayed value system set forth in FIGS. 1-7. Thus, the displayed value is displayed to the player in some increment equal to a common denomination, and is not exactly equal to (i.e., tracks slowly behind) the actual value of the jackpot. To provide an example, assume a player achieves the progressive jackpot in which the displayed award is $11.25 while the actual jackpot value is $11.56. The award value is rounded up to $12.00, leading the player to believe that he or she has received a windfall of $0.75. In this situation, the difference between the award value of $12.00 and the actual value of $11.56, which is $0.44, is then reduced from the escrow pool of $1.00. Hence, the escrow pool starts the next progressive game session with a value of $0.56 and receives the initial contributions until its value is reestablished at $1.00. While the escrow pool is being reestablished to the desired level, the displayed value of the progressive jackpot remains constant at its reset value. In this situation where the displayed value tracks slowly behind the actual value, it is possible to use less of an escrow amount, especially if the amount that it will track behind the actual value is a known value.

Also, while the present invention has been described showing the displayed values changing on the secondary display 27 of the gaming terminal, the displayed value can also change on signage or displays that are adjacent to the gaming terminal 10, as they are typically used in progressive jackpot systems.

Further, it should be noted that while the present invention has been described with respect to a basic game triggering the progressive jackpot, the bonus or secondary game could be equally employed to perform this task. Furthermore, the determination of whether a player has achieved a progressive jackpot can be conducted by the gaming terminal 10 or by the game network 50 (FIG. 2). For example, playing a wagering game (basic game or bonus game) may cause the player to be eligible for the progressive jackpots, and the network 50 then determines whether the player has won. The network 50 may determine whether the player has won one or more of the jackpots in “mystery” fashion such that the player is surprised that he or she has won. The network 50 may instruct the gaming terminal 10 of a progressive game outcome, and the gaming terminal 10 may then display symbols indicative of the progressive game outcome or, in the case of a mystery jackpot, the gaming terminal 10 may then award one or more of the progressive jackpots.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A gaming system, comprising:
a gaming terminal having a wagering game with a plurality of symbols that indicate a randomly selected outcome selected from a plurality of outcomes, said wagering game allowing a player to be eligible for a progressive jackpot having an actual value;
a display for displaying a displayed value for said progressive jackpot, said displayed value being less than said actual value, said displayed value incrementing and being equally divisible by a first denomination; and
a controller coupled to said gaming terminal and said display, said controller operative to:
increase said actual value of said progressive jackpot in response to wager inputs received at said gaming terminal,
increment said displayed value of said progressive jackpot on said display by said first denomination, and
award an award value to a player at said gaming terminal in response to said player achieving said progressive jackpot, said award value being awarded in an increment of a second denomination that is different from and greater than said first denomination.

2. The gaming system of claim 1, further including a plurality of gaming terminals coupled to said controller.

3. The gaming system of claim 1, wherein said wagering game has a second progressive jackpot that is triggered by a second progressive-jackpot outcome, said display displaying a displayed value for said second progressive jackpot.

4. The gaming system of claim 3, wherein said display provides displayed values for a plurality of progressive jackpots in a matrix having multiple rows and multiple columns, said plurality of progressive jackpots including said progressive jackpot and said second progressive jackpot.

5. The gaming system of claim 1, wherein said controller is located remotely from said gaming terminal, and said display is located within said gaming terminal.

6. A method for playing a wagering game on a gaming terminal, said wagering game allowing a player to be eligible for a progressive jackpot having an actual value, said method comprising:
conducting said wagering game having a randomly selected outcome selected from a plurality of outcomes;
displaying a displayed value of said progressive jackpot to said player;
increasing said displayed value by increments of a first denomination; and
awarding a player an award value of said progressive jackpot in response to said player achieving said progressive jackpot, said award value being greater than said displayed value and being equally divisible by a second denomination that is larger than said first denomination.

7. The method of claim 6, wherein said displaying includes continuously increasing said displayed value in response to increases in said actual value.

8. The method of claim 7, wherein said increases in said displayed value always result in said displayed value being less than said actual value.

9. The method of claim 6, further comprising after said awarding, resetting said progressive jackpot to a base value, and, if said award value is less than said actual value, adding to said base value the difference between said actual value and said base value.

10. The method of claim 6, wherein said second denomination is a denomination that is useable as a wager input at said gaming terminal.

11. The method of claim 6, further comprising increasing said actual value of said progressive jackpot by a fixed percentage of wager inputs provided by players competing for said progressive jackpot.

12. The method of claim 6, further comprising increasing said displayed value of said progressive jackpot in response to said actual value remaining constant for a certain period of time to provide an appearance that said progressive jackpot is continuously increasing.

13. The method of claim 6, wherein said wagering game includes a plurality of progressive jackpots, each of said plurality of progressive jackpots having an actual value and a displayed value, said displayed value being equal to or less than an award value of said corresponding progressive jackpot, the method further comprising:
in response to the player being awarded at least two progressive jackpots from said plurality of progressive jackpots, adding said displayed value of said at least two progressive jackpots to result in a total displayed value; and
awarding said player a total award value that is greater than said total displayed value, said total award value being an equal increment of a denomination used fro playing said wagering game.

14. A method for playing a wagering game on a gaming terminal, said wagering game allowing a player to be eligible for a progressive jackpot with an actual value, said method comprising:
in response to wager inputs, conducting said wagering game having a randomly selected outcome selected from a plurality of outcomes;
displaying a displayed value of said progressive jackpot to players competing for said progressive jackpot, said displayed value being less than or equal to an award value of said progressive jackpot;
immediately after said progressive jackpot has been achieved by a player and said progressive jackpot has been reset to a base level, increasing an escrow pool with a portion of said wager inputs, said escrow pool being a value that is at least a maximum difference between said award value and said displayed value; and
after said escrow pool has been established, incrementing said displayed value in response to said wager inputs.

15. The method of claim 14, further including, after said conducting, displaying, increasing, and incrementing, awarding an award value of said progressive jackpot in response to achieving a progressive-jackpot outcome as said randomly selected outcome.

16. The method of claim 15, wherein said award value is more than said displayed value and the difference between said award value and said displayed value is funded by said escrow pool.

17. The method of claim 14, wherein said displayed value is incremented and equally divisible by a first denomination.

18. The method of claim 17, wherein said award value is incremented and equally divisible by a second denomination that is different from and greater than said first denomination.

19. The method of claim 14, wherein said displayed value is less than an award value of said progressive jackpot, and further including (i) awarding said award value of said progressive jackpot in response to a player achieving a progressive-jackpot outcome and (ii) using at least portion of said escrow pool to fund the difference between said displayed value and said award value.

20. The method of claim 14, wherein said wagering game allows the player to be eligible for a plurality of progressive jackpots, each of said plurality of progressive jackpots having an actual value, the method further comprising:
in response to a player being awarded at least two jackpots from said plurality of progressive jackpots, adding said displayed values of said at least two progressive jackpots to result in a total displayed value; and
awarding said player a total award value that is greater than said total displayed value, a difference between said total award value and said total displayed value being funded by said escrow pool.

21. The method of claim 14, wherein said escrow pool is reestablished to a value that is equal to a value prior to said awarding.
